(19) United States
(12) Patent Application Publication
(10) Pub. No.: US 2011/0025061 A1
(43) Pub. Date: Feb. 3, 2011

(54) CONTROL SYSTEM FOR A WINDMILL KITE

(75) Inventor: Bryan William Roberts, Runaway Bay (AU)

Correspondence Address: Altera Law Group, LLC, 220 S 6 St Suite 1700, Minneapolis, MN, 55402, US

(73) Assignee: WONGALEA HOLDINGS OTY LTD, North Sydney (AU)

(21) Appl. No.: 12/936,786

(22) PCT Filed: Apr. 9, 2009
(86) PCT No.: PCT/AU09/00432

§ 371 Date: Oct. 7, 2010

(30) Foreign Application Priority Data
Apr. 14, 2008 (AU) 2008901772

(51) Int. Cl. H02P 9/04

(52) U.S. Cl. 290/44

(57) ABSTRACT

A control system for a windmill kite having a platform tethered by at least one tethering line, and supporting a plurality of rotors that provide lift to keep the kite aloft and to generate electrical power. The control system comprises a computer and controller. The computer comprises a memory circuitry accessible by a microprocessor, the memory circuitry storing data representing at least one set of stored reference values. The controller arranged for regulating at least one functional parameter of the kite by controlling at least one operating characteristic of the rotors, with the computer cyclically retrieving a plurality of sensed environmental parametric values from sensors disposed on or near the kite, and processes a set of output values by comparing the sensed parametric values to the set of stored reference values, the output values are then forwarded to the controller for adjusting at least one operating characteristic of the rotors.

### TECHNICAL FIELD

The present invention relates to a control system for a windmill kite.

### BACKGROUND

U.S. Pat. No. 6,781,254 (Roberts) discloses a windmill kite that converts the energy of the wind into electrical power. The windmill kite comprises a flying platform that contains a plurality of mill rotors, and at least one tethering line for maintaining the windmill kite at a substantially fixed geographic location. The mill rotors provide both the lift for keeping the windmill kite aloft as well as for generating electrical power.

U.S. Pat. No. 7,109,598 (Roberts et al) and U.S. Pat. No. 7,183,663 (Roberts et al) disclose a method of maintaining a windmill kite of the abovementioned type in a defined airspace by use of global positioning system (GPS) for ascertaining the altitude and attitude of the kite.

Whilst the windmill kites of the abovementioned type have been provided with means to control their operation, the control systems have not extracted the maximum power possible and/or maximized the achievable altitude.

The present invention seeks to ameliorate a control system for a windmill kite of the type having a platform tethered by at least one tethering line and supporting a plurality of mill rotors that provide both the lift for keeping the windmill kite aloft as well as for generating electrical power.

### SUMMARY OF THE INVENTION

According to a first aspect the present invention is a control system for a windmill kite of the type having a platform tethered by at least one tethering line and supporting a plurality of mill rotors that provide lift to keep said windmill kite aloft and generate electrical power, said control system comprising a computer and a controller, said computer having a microprocessor and a memory circuitry accessible by said microprocessor, said memory circuitry storing data representing at least one set of stored reference values, said controller arranged for regulating at least one functional parameter of said windmill kite by controlling at least one operating characteristic of said mill rotors, said computer cyclically retrieving a plurality of sensed environmental parametric values from sensors disposed on or near said windmill kite and processes a set of output values by comparing said sensed parametric values to said set of stored reference values, said output values are then forwarded to said controller for adjusting at least one operating characteristic of said mill rotors.

Preferably said at least one set of reference values are configured such that the output values that adjust at least one operating characteristic of said mill rotors substantially optimize said at least one functional parameter without exceeding the safe working load of said at least one tethering line.

Preferably in one embodiment said at least one set of reference values are configured such that the output values that adjust at least one operating characteristic of said mill rotors maximize the electrical power extracted by said mill rotors from the on-coming wind without exceeding the safe working load of said at least one tethering line.

Preferably in another embodiment said at least one set of reference values are configured such that the output values that adjust at least one operating characteristic of said mill rotors to maximize or maintain the altitude of said platform without exceeding the safe working load of said at least one tethering line.

Preferably said plurality of sensed environmental parameters includes wind speed and wind gust level.

Preferably at least one operating characteristic of each of said mill rotors is any one of collective pitch of said rotors, rotor thrust and rotor power.

According to a second aspect the present invention consists in a control system for a windmill kite of the type having a platform tethered by at least one tethering line and supporting a plurality of mill rotors that provide lift to keep said windmill kite aloft and generate electrical power, said control system comprising a computer and a controller, said computer having a microprocessor and a memory circuitry accessible by said microprocessor, said memory circuitry storing data representing at least one set of stored reference values, said controller arranged for regulating at least one of said pitch, yaw or roll parameters of said windmill kite by controlling at least one operating characteristic of said mill rotors, said computer cyclically retrieving a plurality of sensed environmental parametric values including at least wind speed and wind gust level from sensors disposed on or near said windmill kite and processes a set of output values by comparing said sensed parametric values to said set of stored reference values, said output values are then forwarded to said controller for adjusting at least one operating characteristic of said mill rotors, wherein said at least one set of reference values are configured such that the output values that adjust at least one operating characteristic of said mill rotors maximize the electrical power extracted by said mill rotors from the on-coming wind without exceeding the safe working load of said at least one tethering line.

Preferably at least one operating characteristic of each of said mill rotors is any one of collective pitch of said rotors, rotor thrust and rotor power.

According to a third aspect the present invention consists in a control system for a windmill kite of the type having a platform tethered by at least one tethering line and supporting a plurality of mill rotors that provide lift to keep said windmill kite aloft and generate electrical power, said control system comprising a computer and a controller, said computer having a microprocessor and a memory circuitry accessible by said microprocessor, said memory circuitry storing data representing at least one set of stored reference values, said controller arranged for regulating at least one of said pitch, yaw or roll parameters of said windmill kite by controlling at least one operating characteristic of said mill rotors, said computer cyclically retrieving a plurality of sensed environmental parametric values including at least wind speed and wind gust level from sensors disposed on or near said windmill kite and processes a set of output values by comparing said sensed parametric values to said set of stored reference values, said output values are then forwarded to said controller for adjusting at least one operating characteristic of said mill rotors, wherein said at least one set of reference values are configured such that the output values that adjust at least one operating characteristic of said mill rotors maximize or maintain the altitude of said platform without exceeding the safe working load of said at least one tethering line.

Preferably at least one operating characteristic of each of said mill rotors is any one of collective pitch of said rotors, rotor thrust and rotor power.

### BRIEF DESCRIPTION OF THE DRAWINGS

A preferred embodiment of the invention will now be described, by way of example only, with reference to the accompanying drawings in which:

FIG. 1 is a schematic flow diagram of the basic control strategy that may be used to control a windmill kite in accordance with the present invention.

FIG. 2 is a schematic plan view of a four-rotor windmill kite (craft) of the type that can be controlled by the control strategy shown in FIG. 1.

FIG. 3 is a detailed schematic diagram of the control strategy depicted in FIG. 1.

### BEST MODE OF CARRYING OUT INVENTION

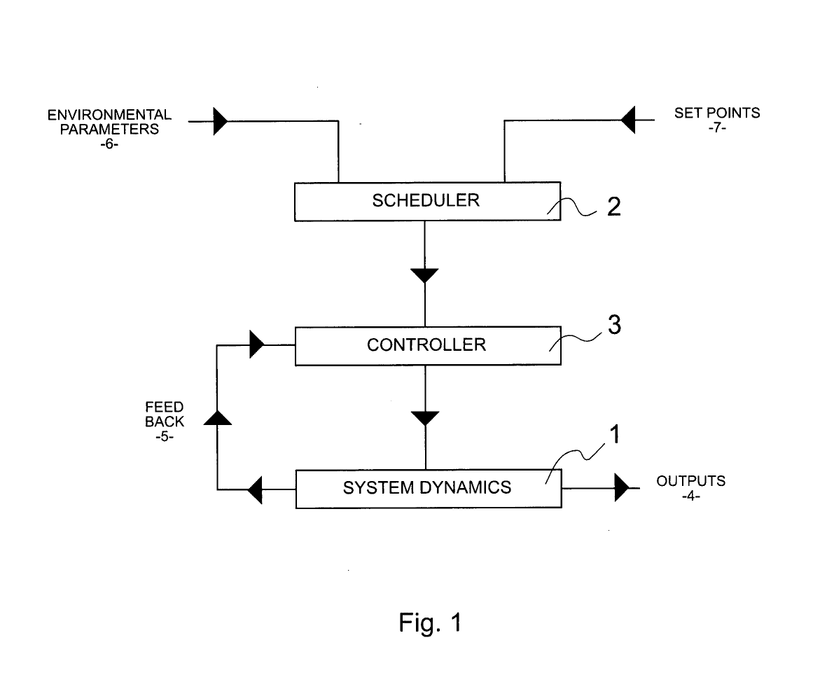

FIG. 1 depicts a flow diagram of the basic control strategy that may be used to control a mechanical, aeronautical and/or similar system. The “system dynamics” 1 represents the actual system being controlled. In this embodiment the system dynamics 1 is for a tethered windmill kite 20 flying at a desired altitude, with the desired pitch, roll and yaw angles relative to the to the on-coming wind direction. The windmill kite 20 may for instance be of the type described in U.S. Pat. No. 6,781,254 (Roberts) having a platform tethered by at least one tethering line and supporting a plurality of mill rotors that provide both the lift for keeping the windmill kite aloft as well as for generating electrical power. The purpose of the control strategy is to maximize the electrical power extracted by the mill rotors of the kite from the on-coming wind without exceeding the safe working load of the tethering line. For ease of reference the windmill kite 20 will throughout this description be referred to as a “craft”.

In the present embodiment, scheduler 2 is a micro-computer with processing and memory capabilities. These capabilities are used to command controller 3 to execute a range of actions in order to yield optimized outputs 4. In other words, the control system in this embodiment is as earlier mentioned configured to maximize the extracted electrical power without exceeding the safe working load in the tethering line, while simultaneously flying at the desired altitude.

The outputs 4 are the altitude and attitude (pitch, roll, yaw) values, plus the level of electrical power being produced, the magnitude of tether tension and a range of other outputs from the rotors. Certain of these outputs 4 are feedback 5 to the controller 3 in order to achieve the desired “optimized” outputs 4. These outputs 4 that may be regulated are so called “functional parameters”. The controller 3 has numerous electro-mechanical components that are later described in detail.

Environmental parameters 6 must be provided to scheduler 2. In this case, the environmental parameters 6 are the mean wind speed (Vbar), approaching craft 20, plus a description of the wind's gust levels, V_{g}. These environmental parameters may be sensed by sensors located on the craft. More details of the wind gust levels is detailed later in the specification.

Set Points (or a set of reference values) 7 must also be provided to the scheduler 2. In the present case the set points 7 are desired altitude and the maxima of power output and tether tension. The set points also include the maximum value of the rotor incidence angle on the retreating blade at 0.4 reference station with the symbol α_{r .max}.

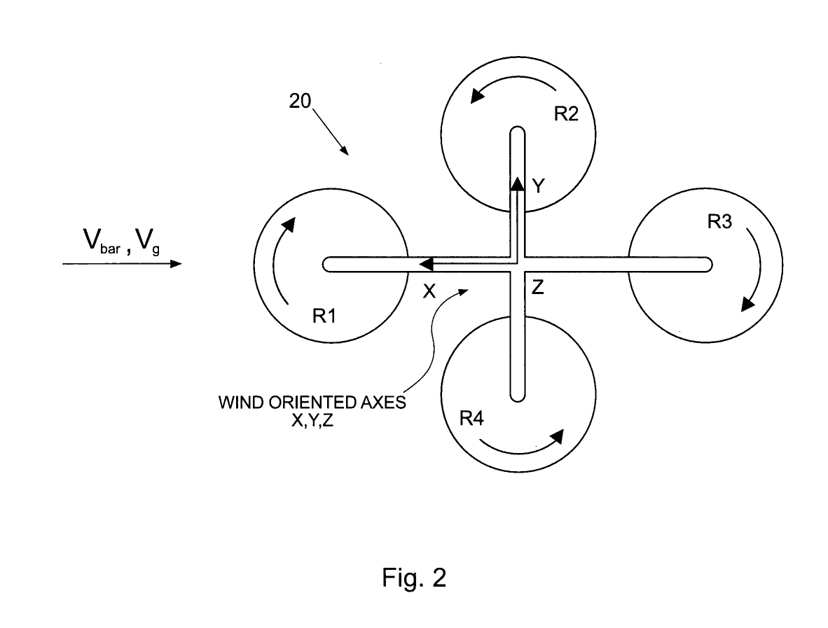

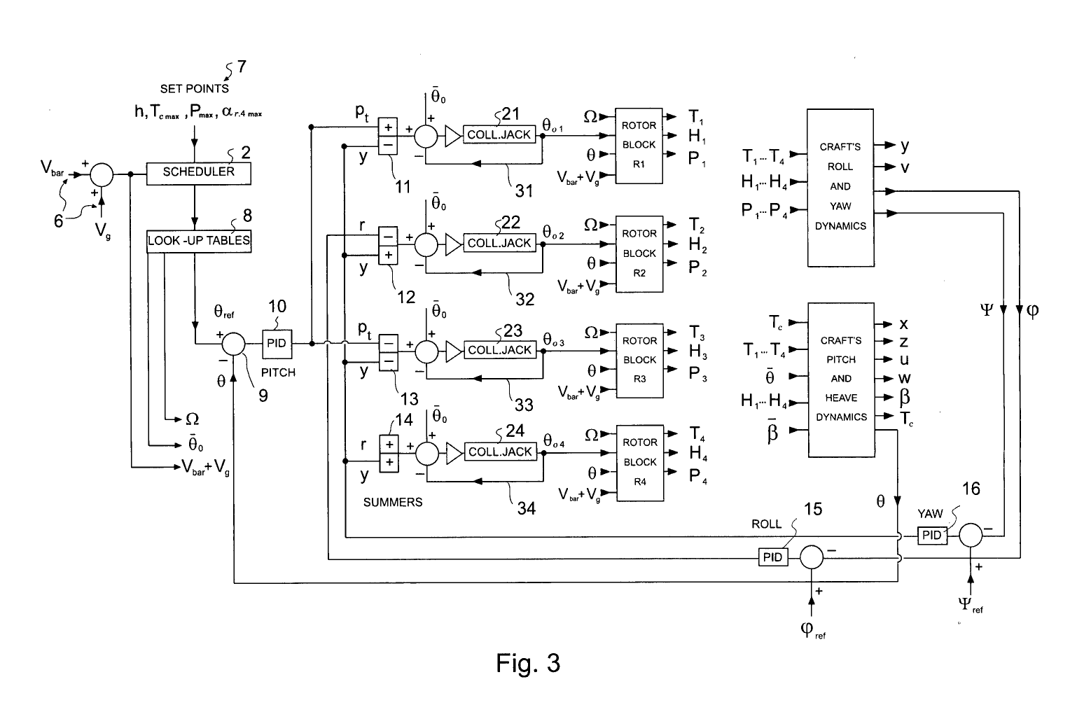

Based on the earlier described control strategy, a control system for craft 20 will now be described with reference to FIGS. 2 and 3.

FIG. 2 is a schematic plan view of four-rotor windmill kite (craft) 20 of the type disclosed in U.S. Pat. No. 6,781,254 having a foremost rotor R₁, a pair of side rotors R₂ and R₄, and a rear rotor R₃. The wind is approaching the four rotors in a direction from left to right. These four rotors are in mutual counter-rotation as indicated by the rotational arrows.

FIG. 3 depicts a schematic of a control system for craft 20 shown in FIG. 2. It should be noted that the earlier mentioned rotors R₁ to R₄ are represented in the centre of FIG. 3 by the four blocks labelled “R1” to “R4”. These four rotors have collective pitch angles θ₀₁ to θ₀₄ respectively, as shown immediately to the left of the respective rotor block.

At the start of the control system the set points 7 are supplied to the scheduler 2 as data inputs. The set point variables are the desired operating altitude h, the maximum safe working load in the tether T_{cmax}, the maximum or rated power level of the system Pₘₐₓ, and the maximum incidence of the flow onto the retreating rotor blade at a conventional reference station α_{r.4max}. The latter value for conventional rotor blades is about 13 degrees. This is as described by Gessow and Myers in their well known standard text “Aerodynamics of the Helicopter”.

Environmental parameters 6 are the mean wind speed Vbar at the time of system operation and the description of wind gusts V_{g} at this same time. These environmental parameters 6 are supplied to scheduler 2 as data inputs, and may be updated once every second.

Scheduler 2 is organized, via a series of computer interrupts, to process a full set of computed outputs that the windmill kite might achieve under a full range of mean and gust wind speeds Vbar and V_{g}. This mass of data is stored in the computer memory of scheduler 2, and after processing in the micro-computer's programs, the necessary controller's data is stored as shown in FIG. 3 as the Look-up Tables (stored reference values) 8. The abovementioned computer interrupts would occur at a frequency of about once per second of operating time. In other words the Look-up memory is overwritten about once per second.

The system next extracts from the Look-up Tables 8 an appropriate master reference value θ_{ref}, for the craft's pitch angle relative to the oncoming wind. With this chosen pitch angle the optimum amount of power, without exceeding the maximum power, may be extracted without exceeding the safe allowable tether tension, and without exceeding the maximum allowable incidence of the retreating rotor-blades. Under these conditions, it follows from Look-up Tables 8 that the revolutions per minute (RPM) and mean collective pitches on all rotors can be set at Ω and θₒ respectively.

Next the known reference value of the craft's pitch angle is compared with the actual value of pitch at the instant in question by comparator 9, and any error signal from comparator 9 is passed to the pitch PID gain block 10, which performs proportional, differential and integral control action. The three gain values are supplied from the look-up tables 8. The output from PID gain block 10 is then applied to the summers 11 and 13 of the respective front rotor R₁ and the rear rotor R₃, where the inputs are made differentially (namely + and −) to the respective collective pitch jacks 21 and 23 in order to produce a differential thrust change on these rotors R₁ and R₃. Thereby a resulting pure moment, that is “a couple”, tends to pitch the craft nose-up or nose-down to correct the error-signal, namely (θ_{ref}−θ). A feedback system 31 and 33 on each respective collective pitch jack 21 and 23 is used to ensure that the error between the desired collective pitch on rotors R₁ and R₃ and their actual pitch is zeroed.

For control of the craft's roll angle a similar system is used. Except that in this case, any difference between the desired and actual roll angle is passed on to the roll PID gain block 15 to the summers 12 and 14 attached to collective roll jacks 22 and 24 on rotors R₂ and R₄. Again these summers 12 and 14 apply the correction differentially using feedback system 32 and 34 on each respective collective roll jack 22 and 24. In this way any roll angle error is corrected by the application of a pure rolling moment that acts to reduce the roll angle error.

Yaw angle control is achieved by differential collective action on the rotor pair R₁ and R₃ against the rotor pair R₂ and R₄. The necessary yawing moment to correct any yaw angle error is achieved by differential torque reaction on the abovementioned rotor pairs. In this case any yaw angle error, via yaw PID block 16, is applied to the rotors R₁ to R₄ through the respective summers 11-14 and thence to the appropriate collective jacks 21-24.

It is important to note that during any collective pitch actions described above, the total thrust on the platform by the rotors R₁ to R₄ is unchanged. Therefore the craft's altitude remains unchanged while the pitch, roll and yaw actions are applied.

If in another not shown embodiment, more than four rotors are used in a different platform configuration, then the outermost four rotors should preferably be selected as the rotors on which to apply the control actions described in the earlier described embodiment. In addition it is unlikely that any other conceivable arrangement of multiple mill rotors will be inherently stable on its tether. If however, such an attitude-stable system were found then the feedback system described above would be unnecessary. Nevertheless, open-loop operation of the system described herein would still be needed, in order to control the relevant power and tether tension levels.

It is also preferable to provide for “control reversal” in the Yaw control system. In a full range of winds, namely Vbar, the control system needs to adapt from a no-wind hovering system, which is powered from the ground, to a generating system that operates in high winds. In other winds within the craft's operating range there is a wind speed condition where the rate of change of torque reaction Tᵣ with a change of rotor collective pitch, namely (dTᵣ/d θₒ), will be zero. At this wind speed the yaw control system will be ineffective. On the lower side of wind speed the summer signs in the yaw connections will be those as shown in the four summers 11-14 in FIG. 3. However, on the upper side of this condition the four summers 11-14, need their yaw signs reversed. To avoid this complication, while such reversal action is possible, it is preferable to retain the lower side control system shown in FIG. 3, but at or above this reversal condition the yaw system is set at inactive. This can be achieved by settings in the scheduler 2. When the yaw system is inactive it is preferable to have at least one conventional ventral fin (a vertical stabilizer), with a rudder attached, control the craft's yaw angle. In addition it is possible to provide a a yaw damper system to stabilize the craft from yaw instability. Details of such a system has not be shown in FIG. 3, as such a system is well known and common place in the prior art of fixed wing aircraft.

The prior art of U.S. Pat. No. 6,781,254 (Roberts) describes principal means for the data acquisition of the altitude and attitude of the craft. Also, U.S. Pat. No. 7,109,598 (Roberts et al) and U.S. Pat. No. 7,183,663 (Roberts et al) describe ascertaining the altitude and attitude of the craft by GPS. However, these variables may be found from the outputs of other systems, namely laser systems, direct reading and rate gyroscopic systems, integrated accelerometer systems, ultrasound systems, microwave systems or differential ground-based radar systems. Any of these systems may be usefully employed to give a data stream for the craft's position and attitude. This data needs to be acquired at a rate faster than the interrupt rate of scheduler 2, and typically at an acquisition frequency of ten times per second. This data would be submitted to the micro-computer of scheduler 2.

In the abovementioned embodiment, it is important to note that whilst the control system or “system dynamics 1” is used to maximize the electrical power extracted by the rotors R₁ to R₄ from the on-coming wind, it must do so without exceeding the safe working load of the tethering line. In order to do so, particular attention is given to a “gust alleviation strategy”, and the tethering line should preferably have a certain flexibility to reduce the loads induced by gusts. In order to not exceed the safe working load of the tethering line, then the input of parameter of wind gust V_{g} to the control system is important.

In U.S. Pat. No. 6,781,254, FIG. 2 therein, shows a 4-rotor craft with a pair of rotors forward and a pair at the rear, all with respect to relative wind. In this case the rotors can be also viewed as a pair starboard and a pair to the port side. The present control system if used for such an arrangement, would need the summers 11-14 to be expanded to have pitch (p) and roll inputs (r) applied at the appropriate pairs, and they thereby act to control the craft's pitch and roll. Yaw inputs are unchanged in this case. Also, if more than four rotors are used, say six rotors instead of four, then there would be six summers with the forward and rear sets of 3 rotors each being used in unison to control pitch and roll as described above. It should be understood that this use of rotor pairs for differential thrust control can be applied to any configuration of rotors which have at least a fore and aft pair for pitch control and a pair laterally spaced apart on the port and starboard sides for roll control. In addition these four can also be used for yaw attitude control as previously described.

The set point variables of the control system of the embodiment described earlier is to maximize the electrical power extracted by the rotors R₁ to R₄ from the on-coming wind, without exceeding the safe working load of the tethering line. However, in another embodiment, there is the situation of utilising the craft as a high altitude observation platform where the object is to fly high, but generate only a small amount of power to maintain the on-board electronics. No power is transmitted to the ground in this case. An example would be a military radar platform riding on the wind with a “non-conducting” tethering line making it a windmill kite unit. In this case “altitude” is to be maximised or maintained while producing only the small amount of power to power the on-board electronics. Another example of a low power, or indeed only a virtually zero power unit, is a high altitude mobile phone platform for use in outback Australia and elsewhere. Here long range coverage is achieved by direct line-of-sight data and voice collection and/or transmission.

In the abovementioned embodiment the sensed environmental parameters 6 including at least wind speed and wind gust level are from sensors disposed on the craft. However, it should be understood that in another embodiment the sensors may be disposed on a like tethered craft flying in a nearby vicinity. Furthermore in another embodiment the sensors may be on the ground or elsewhere. These “ground or elsewhere” sensors may for example form part of a meteorological sensing system, and the necessary environmental parameters 6 received by retrieving data from a website showing the meteorological data.

It is extremely important to appreciate, and highlight that the rotors R₁ to R₄ on the craft all produce lift while simultaneously generating electricity. In all operation modes of the craft the lift is produced solely from the rotors.

### Nomenclature & Definitions Used Herein:

Tᵢ=Rotor's thrust
Hᵢ=Rotor's H force
Pᵢ=Rotor's power output
θₒᵢ=Rotor's collective pitch
Ω=Rotor RPM
H=altitude
V_{g}=wind gust speed
T_{c}=tether tension
B=tether angle
α_{r .4}=blade incidence angle on the retreating blade at 0.4 reference location
x,y,z=standard notation
u,v,w=standard notation
θ, φ, ψ=Standard notation
p_{τ}=pitch
r=roll

Vbar=Mean wind speed approaching the kite

Va=Autorotation wind speed, that is the wind speed where the rotors support the craft and its tether without power being produced or required by the rotors to remain in their elevated state. This condition is exactly analogous to that for the freely spinning, autogyro rotor. Of course Va will increase with increasing altitude due to the extra tether length/weight and also due to a reduction in Earth's air density with increasing altitude.

Vb=The lowest wind speed that produces the maximum designed power output from the kite. This power is often called the rated power of the system. This maximum power is represent by the symbol Pₘₐₓ in what follows.

Vmax=This is the maximum allowable wind speed that can be applied to the kite system.

Therefore, on the above basis we can briefly define three (3) Operation Zones designated as Operation Zones A, B and C below.

Operation Zone A:—0<Vbar<Va: In this mode of operation the power must be supplied from the ground to keep the rotors turning and thereby producing the necessary lift to keep the craft aloft.

Operation Zone B:—Va<Vbar<Vb: In this case a small amount of power may be produced, while sufficient lift is simultaneously produced to keep the system aloft. However, in this zone the power generated will always be less than Pmax. Generally in this state the tether tension is less than the maximum allowable value, designated as T_{c max}.

Operation Zone C:—Vb<Vbar<Vmax: In this zone maximum power, Pmax, is being developed while the tether is also working to its capacity of Tc max. In addition, α_{r .4}, the blade incidence on the retreating blade of the rotor at the reference location, is at its maximum value of α_{r .4 max}. In addition the craft can achieve an altitude of h. Four of these symbols are defined in the Set Points, 7, in the specification of craft 20.

Description of Controller's Function in Operation Zone C:—Vb<Vbar<Vmax: In this range of Vbar the controller is configured to work the craft 20 at full capacity regardless of the value of Vbar. The Scheduler, 2, computes the values of Ω (rotor RPM), θₒ (the rotors' collective pitch), and θ_{ref} (the craft's nose-up attitude). This calculation is configured to ensure that the tether tension is at T_{c max}, the power output is Pₘₐₓ and the rotors are at their aerodynamic or near-stall limit of α_{r .4 max}. In this mathematical and computational process three unknowns (ie Ω, θₒ and θ_{ref}.) have been determined from the three known parameters, Pₘₐₓ, T_{c max} and α_{r .4 max}. It should be noted physically that the system thereby acts at full capacity of power, tension and stall-wise for all values of V bar in this zone. In addition, the tether equilibrium equations, allowing for wind on the tether cable, have been used to determine the craft's altitude, h. All of the above data for a range of Vbar values are then stored in the Look-Up Tables 8.

Description of Controller's Function in Operation Zone B:—Va<Vbar<Vb: In this zone of operation it is impossible to achieve the full power level of Pₘₐₓ. In addition, it is normally found that the tether tension likewise does not reach its limit of Tc max. Nevertheless, it is still important to drive the rotors to their α_{r .4 max} limit in order to achieve the highest possible power output, be it less than Pₘₐₓ. Again the altitude, h, is calculated from the tether's equilibrium equations and the full results-set are again stored in Look-Up Tables 8. Finally, it may be observed that when Vbar=Va the power output is zero, by definition of the variable Va.

Description of Controller's Function in Operation Zone A:—0<Vbar<Va: This zone applies to the situation when power is supplied to craft 20 from the ground to keep the system aloft. The computation process is similar to that described for Operation Zones B and C above. Here again the rotors R₁ to R₄ are driven to capacity so that α_{r .4} equals α_{r .4 max} However, in this case the values of θₒ and θ_{ref} are computed to give the minimum amount of power, P, to keep the system aloft at a height of h. This minimum power level gives the most cost-effective power to stay airborne.

Again the values for Ω, θₒ and θ_{ref} are stored in the Look-Up Tables 8 for this range of values of Vbar.

Control System Actions in Response To Disturbances: The craft will undergo disturbances, which in this section are assumed not to be due to wind gusts. Therefore, Vg=0.

These disturbances to the craft can be of four forms, disturbances to pitch, roll and yaw attitudes and a disturbance to the altitude. These disturbances are shown in FIG. 3 as θ, φ, ψ and a change in altitude.

These disturbances are corrected by feedback action on each of the variables as departures from their referenced values. The feedback loops described here are clearly shown in FIG. 3.

Control System Action in Response to a Wind Gust, Vg;—Gust Alleviation Procedures: The controller has the ability to alleviate gusts as described below. Consider the impact of a square-edged, horizontal gust Vg. In this situation craft 20 will eventually adopt a configuration as described in described for Operation Zones A, B and C above under the action of a wind of velocity (Vbar+Vg). This condition can be found in the Look-Up Tables 8.

However, in the short term a positive gust of Vg will instantaneously increase the rotor thrusts and increase Tc. This increase in Tc will cause the tether to stretch under the increased load thereby causing a downward in-flow into the rotors R₁ to R₄. By so doing the in-flow velocity will relieve, or alleviate, the rotors' thrust increase.

This stretch process can be shown to take between 5 and 10 seconds using conventional materials in a tether reaching to an altitude of say 15,000 feet. The gust's impact eventually allows the control system to reduce the values of the θ_{ref} and θₒ given in the Look-Up Tables 8 for Vbar, where Vbar is the value of V before the gust's arrival.

It may also be noted that coincident with the above alleviation process the tether, as a whole, rotates (in a down-stream direction) about its ground-fixture point after the gust's arrival. Eventually the tether adopts a new position downstream and this transit takes approximately 60 seconds when using a tether reaching to say 15,000 feet.

These stretching and rotation effects of the tether take place simultaneously, but the dynamic stretching process is one tending to alleviate the gust. Eventually the control system adopts parameters applicable to the (Vbar+Vg) velocity as found in the Look-Up Tables 8.

The terms “comprising” and “including” (and their grammatical variations) as used herein are used in inclusive sense and not in the exclusive sense of “consisting only of”.

1. A control system for a windmill kite of the type having a platform tethered by at least one tethering line and supporting a plurality of mill rotors that provide lift to keep said windmill kite aloft and generate electrical power, said control system comprising a computer and a controller, said computer having a microprocessor and a memory circuitry accessible by said microprocessor, said memory circuitry storing data representing at least one set of stored reference values, said controller arranged for regulating at least one functional parameter of said windmill kite by controlling at least one operating characteristic of said mill rotors, said computer cyclically retrieving a plurality of sensed environmental parametric values from sensors disposed on or near said windmill kite and processes a set of output values by comparing said sensed parametric values to said set of stored reference values, said output values are then forwarded to said controller for adjusting at least one operating characteristic of said mill rotors.

2. A control system for a wind mill kite as claimed in claim 1, wherein said at least one set of reference values are configured such that the output values that adjust at least one operating characteristic of said mill rotors substantially optimize said at least one functional parameter without exceeding the safe working load of said at least one tethering line.

3. A control system for a wind mill kite as claimed in claim 2, wherein said at least one set of reference values are configured such that the output values that adjust at least one operating characteristic of said mill rotors maximize the electrical power extracted by said mill rotors from the on-coming wind without exceeding the safe working load of said at least one tethering line.

4. A control system for a wind mill kite as claimed in claim 2, wherein said at least one set of reference values are configured such that the output values that adjust at least one operating characteristic of said mill rotors to maximize or maintain the altitude of said platform without exceeding the safe working load of said at least one tethering line.

5. A control system for a windmill kite as claimed in claim 1, wherein said plurality of plurality of sensed environmental parametric values include wind speed and wind gust level.

6. A control system for a windmill kite as claimed in claim 1, wherein at least one operating characteristic of each of said mill rotors, is any one of collective pitch of said rotors, rotor thrust and rotor power.

7. A control system for a windmill kite of the type having a platform tethered by at least one tethering line and supporting at least four mill rotors that provide lift to keep said windmill kite aloft and generate electrical power, said control system comprising a computer and a controller, said computer having a microprocessor and a memory circuitry accessible by said microprocessor, said memory circuitry storing data representing at least one set of stored reference values, said controller arranged for regulating at least one of said pitch, yaw or roll parameters of said windmill kite by controlling at least one operating characteristic of said mill rotors, said computer cyclically retrieving a plurality of sensed environmental parametric values including at least wind speed and wind gust level from sensors disposed on or near said windmill kite and processes a set of output values by comparing said sensed parametric values to said set of stored reference values, said output values are then forwarded to said controller for adjusting at least one operating characteristic of said mill rotors, wherein said at least one set of reference values are configured such that the output values that adjust at least one operating characteristic of said mill rotors maximize the electrical power extracted by said mill rotors from the on-coming wind without exceeding the safe working load of said at least one tethering line.

8. A control system for a windmill kite as claimed in claim 7, wherein at least one operating characteristic of each of said mill rotors, is any one of collective pitch of said rotors, rotor thrust and rotor power.

9. A control system for a windmill kite of the type having a platform tethered by at least one tethering line and supporting at least four mill rotors that provide lift to keep said windmill kite aloft and generate electrical power, said control system comprising a computer and a controller, said computer having a microprocessor and a memory circuitry accessible by said microprocessor, said memory circuitry storing data representing at least one set of stored reference values, said controller arranged for regulating at least one of said pitch, yaw or roll parameters of said windmill kite by controlling at least one operating characteristic of said mill rotors, said computer cyclically retrieving a plurality of sensed environmental parametric values including at least wind speed and wind gust level from sensors disposed on or near said windmill kite and processes a set of output values by comparing said sensed parametric values to said set of stored reference values, said output values are then forwarded to said controller for adjusting at least one operating characteristic of said mill rotors, wherein said at least one set of reference values are configured such that the output values that adjust at least one operating characteristic of said mill rotors maximize or maintain the altitude of said platform without exceeding the safe working load of said at least one tethering line.

10. A control system for a windmill kite as claimed in claim 9, wherein at least one operating characteristic of each of said mill rotors, is any one of collective pitch of said rotors, rotor thrust and rotor power.
